(19) United States
(12) Patent Application Publication
(10) Pub. No.: US 2024/0248995 A1
(43) Pub. Date: Jul. 25, 2024

(54) SECURITY VULNERABILITY LIFECYCLE SCOPE IDENTIFICATION

(71) Applicant: Microsoft Technology Licensing, LLC, Redmond, WA (US)

(72) Inventors: Jonathan GAZIT, Tel Aviv (IL); Lior BECKER, Modiin-Maccabim-Reut (IL)

(21) Appl. No.: 18/100,598

(22) Filed: Jan. 24, 2023

(51) Int. Cl. G06F 21/57

(52) U.S. Cl. CPC G06F 21/577; G06F 2221/033

(57) ABSTRACT

Some embodiments gather and correlate software artifact identifiers to determine a lifecycle path connecting disparate artifacts from different lifecycle stages. Embodiments support developers or security personnel who are facing inquiries such as which developer can shed light on a particular problematic workload, whether a package based on a particular vulnerable source code has been deployed, and whether a given workload running on a cluster was built with any components that currently have known vulnerabilities. Embodiments proactively fill gaps and resolve ambiguities in a lifecycle path, by using commit-build data structures, build-digest data structures, tag-digest data structures, responses to development tool queries, results of drilling into enclosing packages to find nested package digests, lifecycle graphs, timestamps, and other data.

### BACKGROUND

Attacks on a computing system may take many different forms, including some forms which are difficult to predict, and forms which may vary from one situation to another. Accordingly, one of the guiding principles of cybersecurity is “defense in depth”. In practice, defense in depth is often pursed by forcing attackers to encounter multiple different kinds of security mechanisms at multiple different locations around or within the computing system. No single security mechanism is able to detect every kind of cyberattack, able to determine the scope of an attack or vulnerability, or able to end every detected cyberattack. But sometimes combining and layering a sufficient number and variety of defenses and investigative tools will prevent an attack, deter an attacker, or at least help limit the scope of harm from an attack or a vulnerability.

To implement defense in depth, cybersecurity professionals consider the different kinds of attacks that could be made against a computing system, and the different vulnerabilities the system may include. They select defenses based on criteria such as: which attacks are most likely to occur, which attacks are most likely to succeed, which attacks are most harmful if successful, which defenses are in place, which defenses could be put in place, and the costs and procedural changes and training involved in putting a particular defense in place or removing a particular vulnerability to attack. They investigate the scope of an attack, and try to detect vulnerabilities before they are exploited in an attack. Some defenses or investigations might not be feasible or cost-effective for the particular computing system. However, improvements in cybersecurity remain possible, and worth pursuing.

### SUMMARY

Some embodiments described herein address technical challenges of computer technology, and more particularly technical challenges in identifying the scope of performance flaws and security vulnerabilities in a collection of artifacts such as source code files, compiled binary files, deployed packages, and other artifacts. Failure to properly identify the software development dependencies between artifacts inhibits the removal or mitigation of functional problems from software, leading to problem “solutions” that are unnecessarily inefficient or incomplete, or both.

Some embodiments described herein start with a particular artifact and then obtain and correlate artifact identifiers to identify additional development artifacts from other stages of the artifact's lifecycle, in order to ascertain the lifecycle scope of a performance flaw or a security vulnerability. The starting point in the lifecycle varies; in a given situation some embodiments use any of the following as the correlation starting point: a build identifier, a cluster identifier, a commit identifier, a developer identifier, a package digest, a package name, a package tag, a source code file name, a virtual machine identifier, or a workload identifier. During artifact identifier correlation, some embodiments fill gaps in a sequence of development-dependent identifiers, and some embodiments resolve ambiguities in the sequence.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. To the extent this Summary conflicts with the claims as properly understood, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media, including some aspects generally suitable for systems which provide vulnerability scope ascertainment functionality;

FIG. 2 is a block diagram illustrating a development environment and an enhanced system which is configured with a vulnerability scope ascertainment functionality;

FIG. 3 is a block diagram illustrating aspects of a system enhanced with various aspects of vulnerability scope ascertainment functionality;

FIG. 4 is a block diagram illustrating some software lifecycle artifact identifiers and related items;

FIG. 5 is a flowchart illustrating steps in some vulnerability scope ascertainment processes;

FIG. 6 is a flowchart further illustrating steps in some vulnerability scope ascertainment processes, and incorporating FIG. 5;

FIG. 7 is a data flow diagram illustrating aspects of a software lifecycle of a cloud-native workload artifact;

FIG. 8 is a data flow diagram illustrating aspects of a vulnerability mitigation architecture with vulnerability scope ascertainment functionality; and

FIG. 9 is a graph illustrating artifact paths in a lifecycle.

### DETAILED DESCRIPTION

### Overview

Some tools that track related artifacts during a software development lifecycle focus on particular stages of the lifecycle. For example, many source code version control tools track connections between developer IDs and source code, but are not designed to connect developer IDs to deployed binaries eventually built from given source code. Many deployment tools map a binary code to some kind of identifier, but various identifiers are used, such as digests or tags or file names, and the mappings are also not always one-to-one. More generally, gaps and ambiguities make it challenging to reliably and efficiently connect a particular developer ID to a particular deployed binary workload, and to identify the intervening artifacts between source code and the deployed binary in a path through the software development lifecycle.

However, data gaps can be filled and ambiguities can be resolved, by a new vulnerability scope ascertainment functionality, when certain technical challenges are met. One challenge is for the functionality to obtain sufficient access to the artifact tracking data of individual software development tools. Another challenge is for the functionality to apply insights into the overall lifecycle in a practical manner to correlate selected identifiers into a lifecycle sequence. This has a constituent challenge of defining the gaps and ambiguities in lifecycle data and specifying how to fill the gaps and how to resolve the ambiguities.

Some embodiments described herein meet these and other technical challenges and provide technical benefits as a result.

For example, some embodiments fill a gap between a lifecycle write stage 712 and a lifecycle build stage 714 by populating a collection of lifecycle correlations using a commit-build data structure which associates a commit identifier with a build identifier. This has the benefit of connecting a particular version of source code with a particular executable built that was using the particular version of the source code, thereby filing a gap between two stages of the development lifecycle and also resolving an ambiguity often left unresolved by file names alone. Filling the gap and resolving the ambiguity in turn lead to improved software performance and security as vulnerabilities are tracked back to their underlying source code or forward to their presence in deployed code.

Some embodiments fill a gap between a lifecycle build stage 714 and a lifecycle deploy stage 716 by populating a collection of lifecycle correlations using a build-digest data structure which associates a build identifier with a package digest. This has the benefit of connecting a particular executable with a package that contains the particular executable, thereby filing a gap between two stages of the development lifecycle and also resolving an ambiguity often left unresolved by file names, package tags, and logs. Filling the gap and resolving the ambiguity in turn lead to improved software performance and security as vulnerabilities are tracked back to their underlying source code or forward to their presence in deployed code.

Some embodiments determine a nested package digest from an enclosing package digest. This has the benefit of resolving an ambiguity created when the enclosing package digest is logged as the digest of a deployed package but in fact the enclosing package contains multiple nested packages and only one of the nested packages—which one is not specified in the log—was actually deployed in connection with the logged event. Resolving the ambiguity in turn leads to improved software performance and security as vulnerabilities are tracked back to their underlying source code or forward to their presence in deployed code.

Some embodiments determine a package digest using a workload tag of a workload which is marked as having a vulnerability and using a timestamp of the workload. This has the benefit of resolving an ambiguity created as different packages or package versions are deployed and logged using the same package tag at different times. Resolving the ambiguity in turn leads to improved software performance and security as vulnerabilities are tracked back to their underlying source code or forward to their presence in deployed code.

Some embodiments get a virtual machine identifier and then obtain a lifecycle identifier from the virtual machine identifier, wherein the lifecycle identifier includes at least one of a workload identifier, a package digest, or a package tag. This has the benefit of helping to resolve an ambiguity created as different packages or package versions are deployed in different versions of a virtual machine or deployed in different virtual machines, or both. Resolving the ambiguity in turn leads to improved software performance and security as vulnerabilities are tracked back to their underlying source code or forward to their presence in deployed code.

Some embodiments get a cluster identifier and then obtain a lifecycle identifier from the cluster identifier, wherein the lifecycle identifier includes at least one of a workload identifier, a package digest, or a package tag. This has the benefit of helping to resolve an ambiguity created as different packages or package versions are deployed to a cluster. Resolving the ambiguity in turn leads to improved software performance and security as vulnerabilities are tracked back to their underlying source code or forward to their presence in deployed code.

These and other benefits will be apparent to one of skill from the teachings provided herein.

### Operating Environments

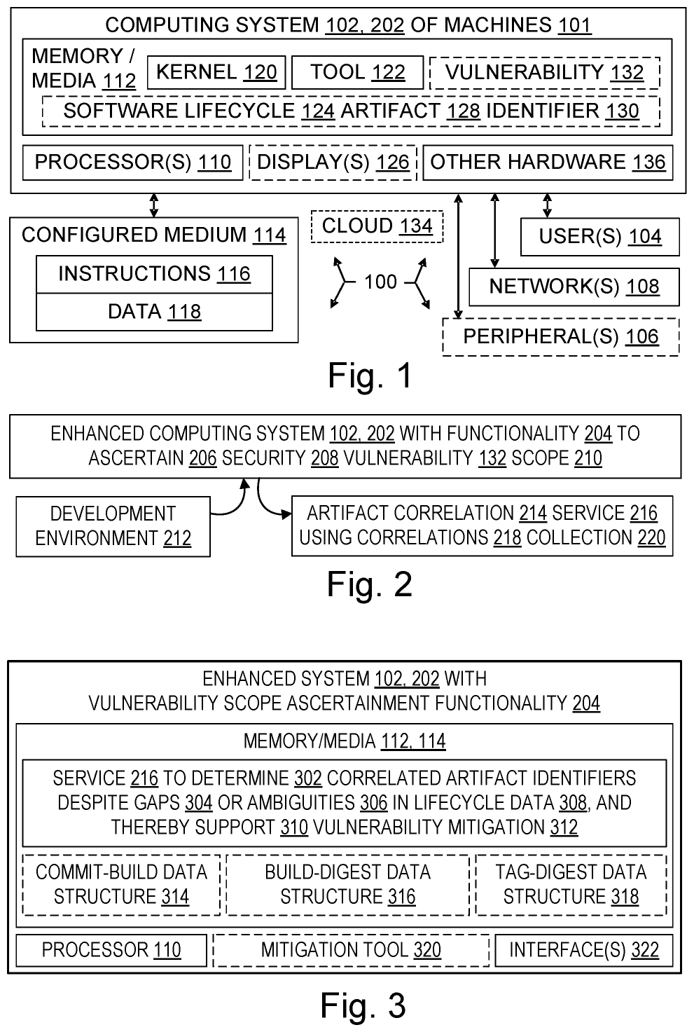

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 134. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 sometimes interact with a computer system 102 user interface by using displays 126, keyboards 106, and other peripherals 106, via typed text, touch, voice, movement, computer vision, gestures, and/or other forms of I/O. Virtual reality or augmented reality or both functionalities are provided by a system 102 in some embodiments. A screen 126 is a removable peripheral 106 in some embodiments and is an integral part of the system 102 in some embodiments. The user interface 322 supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices or networking devices or both are considered peripheral equipment in some embodiments and part of a system 102 in other embodiments, depending on their detachability from the processor 110. In some embodiments, other computer systems not shown in FIG. 1 interact in technological ways with the computer system 102 or with another system embodiment using one or more connections to a cloud 134 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software apps, on mobile devices 102 or workstations 102 or servers 102, compilers and other software development tools, as well as APIs, browsers, or webpages and the corresponding software for protocols such as HTTPS, for example. Files, APIs, endpoints, and other resources may be accessed by an account or set of accounts, user 104 or group of users 104, IP address or group of IP addresses, or other entity. Access attempts may present passwords, digital certificates, tokens or other types of authentication credentials.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment is described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, some embodiments include one of more of: hardware logic components 110, 136 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUS, and/or quantum processors), memory/storage media 112, peripherals 106, and displays 126, some operating environments also include other hardware 136, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 136 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments, one or more computers are partially or fully “air gapped” by reason of being disconnected or only intermittently connected to another networked device or remote cloud. In particular, vulnerability scope ascertainment functionality 204 could be installed on an air gapped network and then be updated periodically or on occasion using removable media 114, or not updated at all. Some embodiments also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some embodiments. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was previously known.

In any later application that claims priority to the current application, reference numerals may be added to designate items disclosed in the current application. Such items may include, e.g., software, hardware, steps, processes, systems, functionalities, mechanisms, data structures, resources, machine learning or statistical or other correlation algorithm implementations, or other items in a computing environment, which are disclosed herein but not associated with a particular reference numeral herein. Corresponding drawings may also be added.

More about Systems

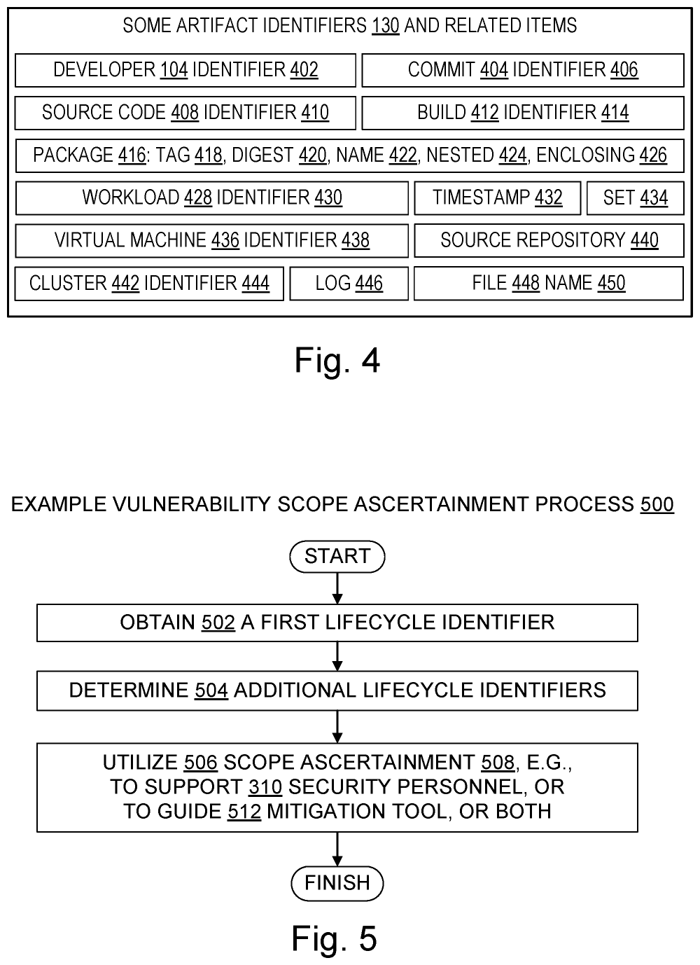

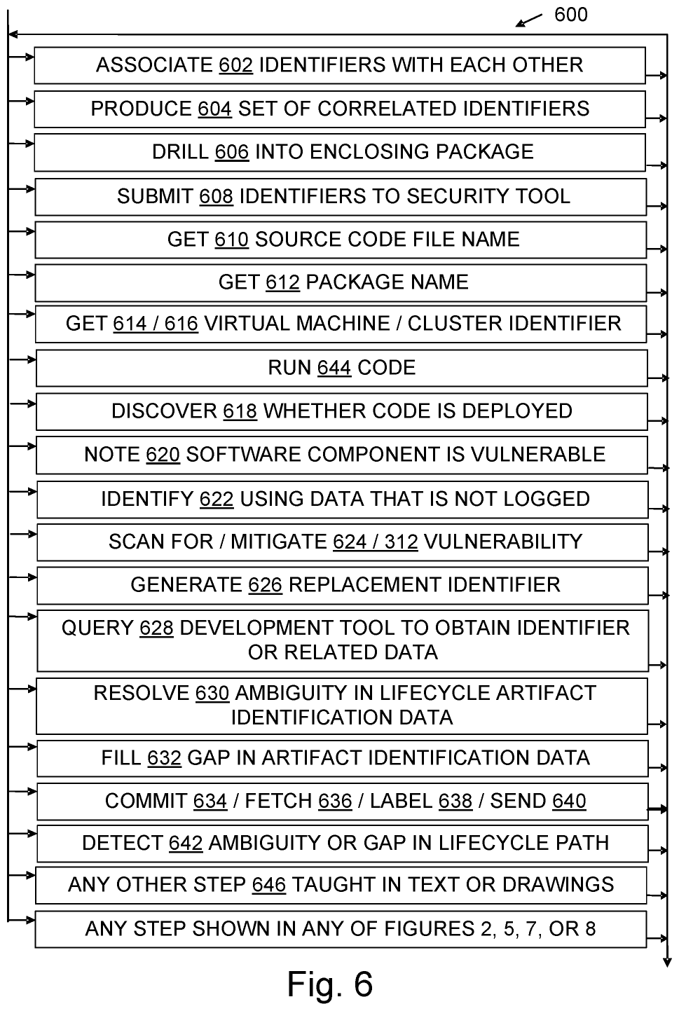

FIG. 2 illustrates a computing system 102 configured by one or more of the vulnerability scope ascertainment enhancements taught herein, resulting in an enhanced system 202. In some embodiments, this enhanced system 202 includes a single machine, a local network of machines, machines in a particular building, machines used by a particular entity, machines in a particular datacenter, machines in a particular cloud, or another computing environment 100 that is suitably enhanced. Although shown separately in FIG. 2, the system 202 or the artifact correlation service 216 or both are part of the development environment 212 in some embodiments. Likewise, the service 216 is part of the system 202 in some embodiments. FIG. 2 items are discussed at various points herein, and additional details regarding them are provided in the discussion of a List of Reference Numerals later in this disclosure document.

FIG. 3 shows some aspects of some enhanced systems 202. This is not a comprehensive summary of all aspects of enhanced systems 202 or all aspects of vulnerability scope ascertainment functionality 204. Nor is it a comprehensive summary of all aspects of an environment 100 or system 202 or other context of an enhanced system 202, or a comprehensive summary of all vulnerability scope ascertainment mechanisms 204 for potential use in or with a system 102. FIG. 3 items are discussed at various points herein, and additional details regarding them are provided in the discussion of a List of Reference Numerals later in this disclosure document.

FIG. 4 shows some artifact identifiers 130 and related items such as logs 446, timestamps 432, and so on. This is not a comprehensive summary of all identifier-related aspects of enhanced systems 202 or all aspects of artifact 128 identification in vulnerability scope ascertainment functionality 204. FIG. 4 items are discussed at various points herein, and additional details regarding them are provided in the discussion of a List of Reference Numerals later in this disclosure document.

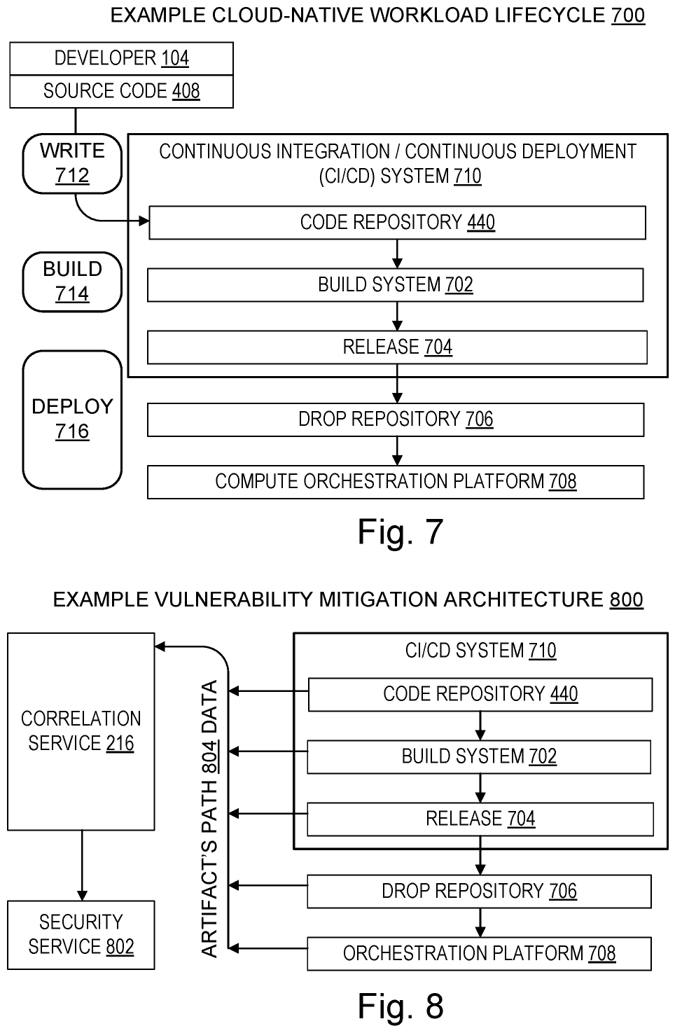

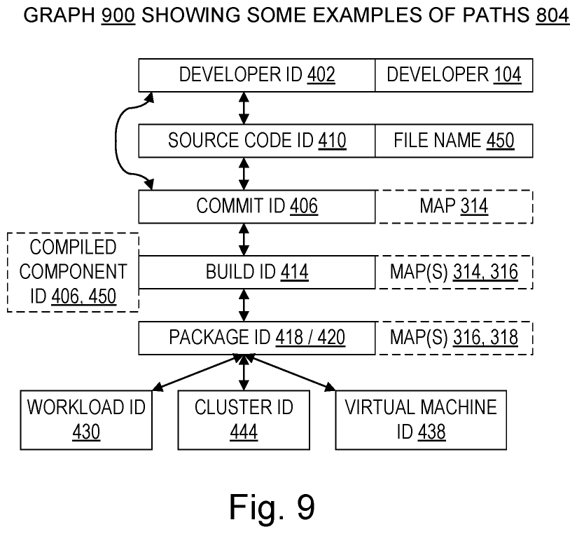

The other figures are also relevant to enhanced systems 202. In particular, FIGS. 5 and 6 illustrate processes of system 202 operation, FIG. 7 illustrates a software development lifecycle 124, 700 which uses and produces artifacts tracked by systems 202, and FIG. 8 illustrates an architecture 800 for vulnerability mitigation using vulnerability scope ascertainment functionality 204 of an enhanced system 202. FIG. 9 shows paths which correspond to vulnerability scopes.

In some embodiments, the enhanced system 202 is networked through an interface 322. In some, an interface 322 includes hardware such as network interface cards, software such as network stacks, APIs, or sockets, combination items such as network connections, or a combination thereof.

Some embodiments include a computing system 202 which creates or is given a mapping 314 between a commit ID and a build ID, and creates or is given a mapping 316 between a build ID and a package digest. Then the system 202 uses those mappings and other data such as timestamps to correlate 218 all of the following lifecycle info: a developer ID 402, source code 408, the commit ID 406, the build ID 414, a package digest 420, and a workload 428. Timestamps may be harvested from logs, tool query responses, registries, and other sources, depending on the particular environment.

Some embodiments include a software development computing system 202 which includes: a digital memory 112 and a processor set 110 including at least one processor, the processor set in operable communication with the digital memory. The system 202, which is capable of ascertaining 206 a lifecycle scope 210 of a software security vulnerability 132, also includes a collection 220 of lifecycle correlations 218 residing in and configuring the digital memory. The collection 220 includes a commit-build data structure 314 which associates 602 a commit identifier 406 with a build identifier 414 as representing artifacts on the same lifecycle path 804, and a build-digest data structure 316 which associates 602 a build identifier 414 with a package digest 420. The system 202 also includes a correlation service 216 which upon execution by the processor set produces 604 a set 434 of correlated lifecycle identifiers 130. In this example, the set 434 includes: a developer identifier 402, a source code identifier 410 which identifies a source code 408 that was committed 634 to a source repository 440 under the developer identifier and was given the commit identifier, the source code corresponding to a package 416 that was built 714 using at least the source code, and a workload identifier 430 which identifies a workload 428 that includes the package.

In some environments 100, a package 416 is permitted to be an enclosing package 426 that includes nested packages 424 that each target different processor 110 architectures or different operating systems 120, for example, or different licensing contexts, or different intended users 104. Some embodiments operate in scenarios in which a package 424 is nested inside a larger package 426. In some cases, the digest 420 listed in a log 446 is not a suitable architecture-specific package's digest because it only matches an enclosing package.

However, when a log 446 only lists the enclosing package's digest, some embodiments drill down 606 to find the nested digest that matches the workload's actual processor architecture and operating system or digest of a particular package that was actually deployed 716.

In some embodiments, the package 416 is a nested package 424 within an enclosing package 426 and the package digest 420 is a nested package digest, the enclosing package 426 includes at least one other nested package 424 having a respective other nested package digest, and the enclosing package 425 has a respective enclosing package digest.

As a simplified example, a peripheral driver package P-all has a digest 12345000. The package P-all is an enclosing package 426 which contains three nested packages 424: package P-archA with digest 12345001, which has code tailored to processor 110 architecture A, package P-archB with digest 12345002, which has code tailored to processor 110 architecture B, and package P-archC with digest 12345003, which has code tailored to processor 110 architecture C.

A workload 428 is running or ran on a machine X, which has processor 110 architecture B. The workload is marked 620 as having a vulnerability 132, e.g., a performance flaw or an exploitable cybersecurity shortcoming. Manual or automatic investigation leads to a log 446 entry indicating that the workload 428 running on machine X includes package #12345000. An embodiment then automatically determines that 12345000 is the digest of an enclosing package, so the embodiment recognizes 642 that the log entry is ambiguous 306 as to which nested package actually ran on machine X.

Accordingly, the embodiment utilizes other lifecycle data 308 to identify the correct nested package. For example, in some cases an embodiment uses nested package metadata and machine X system data to match the processor 110 architecture B of package P-archB to the processor 110 architecture B of machine X. In some cases, an embodiment queries a deployment tool 122 such as an orchestration platform 708 to find a digest 420 indicating deployment of package P-archB. In some cases, an embodiment checks one or more characteristics such as binary size, last modification timestamp, vendor, or version number of the deployed package against the nested packages to rule in package P-archB or at least rule out some of the other nested packages of P-all. These techniques are also combined in some embodiments and in some circumstances. In short, the embodiment determines that the nested package deployed was package P-archB, which has digest 12345002. This determination resolves 630 the ambiguity created by the log entry that listed the digest 12345000 of the enclosing package P-all.

In some embodiments, the digital memory is also configured by a tag-digest data structure 318 which associates 602 a package tag 418 with a package digest 420 and a timestamp 432.

In some environments, a package tag 418 is permitted to correspond to different package digests 420 at different times. Some embodiments include or utilize a data structure 318 to track the mapping between tags and digests, using timestamps 432. In one scenario, for example, a workload 428 has a vulnerability but only the workload's package's tag 418 is known; this is also referred to as the workload's tag 418. Using the mapping structure 318 and a workload timestamp 432, the embodiment follows the tag 418 to the digest 420, which leads in turn to the build ID 414, commit ID 406, source code 408, and developer ID 402.

As a simplified example, a workload 428 is marked 620 as having a vulnerability 132. The default log or other telemetry shows the workload is tagged with a tag “latest”. However, an embodiment recognizes 642 that tags 418 are presumptively ambiguous 306 because different versions of a workload (and hence different package versions or even different packages) get tagged with the same tag when they run at different times or on different machines or both. In this example, the embodiment queries 628 an orchestration platform 708 or checks non-default log or other telemetry to find that deployment of the vulnerable workload 428 occurred at time 34534560000. The embodiment consults a tag-digest data structure which it maintains based on available logs, telemetry, and other data, and finds the following data for tag “latest”:

| Time | Digest |
|---|---|
| 34534320000 | 12555006 |
| 34534440000 | 12555013 |
| 34534560000 | 12555014 |
| 34534600000 | 12555025 |
| 34534730000 | 12555077 |

Thus, the digest for the package deployed under the tag “latest” at time 34534560000 is digest 12555014. Based on this, the embodiment correlates the particular vulnerable version of the package with a digest, which as taught herein leads the embodiment to a build identifier, a commit identifier, a particular version of source code, and one or more developer identifiers.

Other system embodiments are also described herein, either directly or derivable as system versions of described processes or configured media, duly informed by the extensive discussion herein of computing hardware.

Although specific vulnerability scope ascertainment architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of vulnerability scope ascertainment functionality, for example, as well as different technical features, aspects, mechanisms, software, expressions, operational sequences, data structures, environment or system characteristics, tool query capabilities, telemetry, logs, or other functionality consistent with teachings provided herein, and may otherwise depart from the particular examples provided.

Processes (a.k.a. Methods)

Processes (which are also be referred to as “methods” in the legal sense of that word) are illustrated in various ways herein, both in text and in drawing figures. FIGS. 5 and 6 each illustrate a family of processes 500 and 600 respectively, which are performed or assisted by some enhanced systems, such as some systems 202 or another vulnerability scope ascertainment enhanced system as taught herein. Process family 500 is a proper subset of process family 600.

FIGS. 1 to 4 illustrate vulnerability scope ascertainment system 202 architectures with implicit or explicit actions, e.g., logging 446 software development events which create or modify or otherwise access artifacts 128, executing software development tools 122, 320, or otherwise processing data 118, in which the data 118 includes, e.g., artifacts 128, artifact identifiers 130, digital representations of vulnerabilities 132, data structures 220, 314, 316, 318, and timestamps 432, among other examples disclosed herein. FIG. 7 illustrates a software lifecycle 124, 700 of a cloud-native workload artifact; a lifecycle 124 has steps corresponding to or being steps of some processes 600. FIG. 8 illustrates a vulnerability mitigation architecture which embodies steps of some processes 600. FIG. 9 shows some overlapping paths in a software lifecycle 124.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated, e.g., in some situations a human 104 types in a file name 450. But no process claimed herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 6. FIG. 6 is a supplement to the textual examples of embodiments provided herein and the textual descriptions of embodiments provided herein. In the event of any alleged inconsistency, lack of clarity, or excessive breadth due to an aspect or interpretation of FIG. 6, the text of this disclosure shall prevail over that aspect or interpretation of FIG. 6.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 600 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 6 to be non-operable, the sequence S is not within the scope of any claim. Any assertion otherwise is contrary to the present disclosure.

In some cases, an embodiment starts with a workload 428 and ascertains 206 a path 804 from the workload back through a development lifecycle to source code 408, or even further back to a developer 104. For instance, software performance or security or both are improved when a cause is found for a workload vulnerability, mitigated in the source code, and the vulnerable workload is replaced by a better version.

In some cases, an embodiment starts with some source code 408, and tries to track a path 804 forward to determine whether a workload based on the source code has been deployed, or even built. Software performance or security or both are improved if any vulnerable workloads are detected, preferably before they are deployed.

Some embodiments improve the security function of a computing system 212 in scenarios that start with a piece of data about an initial artifact 128. This may be the kind of data that is a starting point in many investigations, such as a source code file 448, a package name 422, a virtual machine identifier 438, or a cluster identifier 444. The embodiments automatically and proactively use the initial piece of data to determine 504 multiple lifecycle identifiers 130 on a path 804 through the development lifecycle 124 that includes the initial artifact.

For example, some embodiments start (or continue) path 804 determination 504 with a source file name 450 and query 628 a repository 440 to get a list of developer identifiers 402 and commit identifiers 406 that correspond to the named source code file 448. The developer identifiers 402 identify developers 104 who committed 634 the named source code file 448 to the repository 440, which assigned the commit identifiers 406 to identify the commits 634.

Some embodiments start (or continue) path 804 determination 504 with a package name 422 and query 628 a build system 702 to get build pipeline data including a list of package digests 420 and (in some cases) package tags 418 which correspond to packages having the package name or to constituent artifacts thereof.

Some embodiments start (or continue) path 804 determination 504 with a virtual machine identifier 438 and query 628 a deployment tool 122 or orchestration platform 708 data to get a workload identifier 430, a package digest 420, or a package tag 418 corresponding to code deployed to the identified virtual machine 436. In some environments, an orchestrator 708 provides data showing which packages (which digests) are part of a given virtual machine.

Some embodiments start (or continue) path 804 determination 504 with a cluster identifier 444 and query 628 a deployment tool 122 or orchestration platform 708 data to get a workload identifier 430, a package digest 420, or a package tag 418 corresponding to code deployed to the identified cluster 442. In some environments, an orchestrator 708 provides data showing which packages (which digests) were deployed to a given cluster.

In some environments and some scenarios, an issue 132 at runtime or in a package repo 706 or a registry 706, for example, provides context which an embodiment leverages to obtain or determine lifecycle identifiers along a path 804. The issue 132 may be a performance flaw, or a security vulnerability, for example. The issue may become apparent from decreased performance, from a crash, from a hang due to deadlock, from a scan for security vulnerabilities, from static analysis, from a notice or notification of previously unknown exploitable deficiencies, from a change in operational specifications or operational procedures or governing policies or regulations, or from other circumstances.

By improving computer functionality which correlates software lifecycle identifiers to allow efficient and effective bug fixes, performance improvements, and security upgrades, various embodiments improve computing system functioning. For example, if a vulnerability 132 is found in code in a CI/CD 710, some embodiments improve vulnerability detection and tracking by determining whether the vulnerability has traveled beyond the CI/CD to a deployment stage 716 of the lifecycle 124. Similarly, if a vulnerability is found in a repo 706 or a registry 706, some embodiments determine 504 where it was pushed from and who manages the code so that the code can be efficiently and effectively fixed.

Some embodiments provide or utilize a process 600 performed by computing system 202 to ascertain a lifecycle scope 210 of a vulnerability of a software artifact 128. The process includes: obtaining 502 a first lifecycle identifier 130 of the software artifact; determining 504 at least three additional lifecycle identifiers of the software artifact, based on at least the first lifecycle identifier, wherein the obtaining 502 and the determining 504 collectively identify a set 434 of lifecycle identifiers which includes at least four of the following: a developer identifier 402, a commit identifier 406, a build identifier 414, a package digest 420, a package tag 418, or a workload identifier 430; and submitting 608 the set of lifecycle identifiers to a security vulnerability mitigation tool 320 or a software development tool 122.

Some embodiments provide or utilize a process 600 which includes at least one of: getting 610 a source code file name and then obtaining 502 the first lifecycle identifier from the source code file name, wherein the first lifecycle identifier includes at least one of a developer identifier or a commit identifier; getting 612 a package name and then obtaining 502 the first lifecycle identifier from the package name, wherein the first lifecycle identifier includes at least one of a package digest or a package tag; getting 614 a virtual machine identifier and then obtaining 502 the first lifecycle identifier from the virtual machine identifier, wherein the first lifecycle identifier includes at least one of a workload identifier, a package digest, or a package tag; or getting 616 a cluster identifier and then obtaining 502 the first lifecycle identifier from the cluster identifier, wherein the first lifecycle identifier includes at least one of a workload identifier, a package digest, or a package tag.

Some embodiments provide or utilize a process 600 which includes discovering 618 whether executable code based on a vulnerable software component has been deployed, by utilizing 506 the set 434 of lifecycle identifiers. The vulnerable software component could be, for example, a source code file 448, a configuration file 448, or a binary file 448 output by a compiler, which the embodiment connects to one or more lifecycle paths using, e.g., commit IDs 406 or build IDs 414. Then the embodiment determines 504 whether any additional identifiers 130 in those paths identify a deployed package 416.

Some embodiments provide or utilize a process 600 which includes noting 620 that a software component is vulnerable and identifying 402 a developer who contributed to the software component, by utilizing 506 the set of lifecycle identifiers. More generally, some embodiments use the lifecycle identifiers to identify a developer 104 who contributed to vulnerable software. Note that this capability is not meant to help place blame on anyone. The identified developer is not necessarily responsible for the vulnerability—the vulnerability may be due to a different developer's contribution, or due to circumstances the developer could not have known about when the contribution was made. Rather, the developer who contributed to the component is probably a good source of information about the component, and may be able to help mitigate the vulnerability.

Some embodiments provide or utilize a process 600 which identifies 622 the set of lifecycle identifiers based at least partially on information 118 that is not present in any log 446 in the computing system. For instance, in some scenarios the logs 446 only provide an enclosing package's digest, but the embodiment drills 606 into that enclosing package to find nested package digests and then uses data 118 about deployed code to determine which nested package actually ran. In some scenarios, correlations 218 are derived from data 118 the embodiment receives in response to querying 628 a development tool 122 (e.g., a code repository 440, build system 702, or orchestrator 708) instead of from logs 446.

In some environments and scenarios, a package 424 is nested inside a larger package 426. As a result, the digest 420 listed in a log may identify the outer package, which is ambiguous with regard to code actually deployed. Accordingly, when a log only lists the enclosing package's digest, some embodiments drill down 606 to find the nested digest that matches the workload's actual processor architecture and operating system. In some embodiments, the process 600 determines a nested package digest from an enclosing package digest, e.g., using a package manifest 118.

In one scenario, a workload 428 has a vulnerability 132 and only the workload tag is known; the digest is not logged 446. Using a mapping 318 and a workload timestamp, the tag leads to the digest, which leads in turn to the build ID, commit ID, source code, and developer ID. In some embodiments, the process 600 determines 504 a package digest using a workload tag 418 of a workload which is marked as having a vulnerability and using a timestamp 432 of the workload.

In some embodiments, the obtaining 502 and the determining 504 collectively identify the set 434 of lifecycle identifiers, and the set of lifecycle identifiers includes at least five of the following: a developer identifier, a commit identifier, a build identifier, a package digest, a package tag, or a workload identifier.

In some embodiments, the obtaining 502 and the determining 504 collectively identify the set 434 of lifecycle identifiers, and the set of lifecycle identifiers includes a developer identifier, a commit identifier, a build identifier, a package digest, a package tag, and a workload identifier.

In some embodiments, the process 600 includes at least one of the following determinations 504: determining 504 the package digest using the build identifier or determining 504 the build identifier using the package digest; determining 504 the package digest using the workload identifier or determining 504 the workload identifier using the package digest; determining 504 the package digest using the commit identifier or determining 504 the commit identifier using the package digest; determining 504 the package digest using the developer identifier or determining 504 the developer identifier using the package digest; determining 504 the workload identifier using the commit identifier or determining 504 the commit identifier using the workload identifier; or determining 504 the workload identifier using the developer identifier or determining 504 the developer identifier using the workload identifier. In some embodiments, the process 600 includes at least two of the determinations. In some embodiments, the process 600 includes at least three of the determinations. In some embodiments, the process 600 includes at least four of the determinations. In some embodiments, the process 600 includes at least five of the determinations. In some embodiments, the process 600 includes at least six of the determinations.

### Configured Storage Media

Some embodiments include a configured computer-readable storage medium 112. Some examples of storage medium 112 include disks (magnetic, optical, or otherwise), RAM, EEPROMS or other ROMs, and other configurable memory, including in particular computer-readable storage media (which are not mere propagated signals). In some embodiments, the storage medium which is configured is in particular a removable storage medium 114 such as a CD, DVD, or flash memory. A general-purpose memory, which is be removable or not, and is volatile or not, depending on the embodiment, can be configured in the embodiment using items such as a commit-build data structure 314, a build-digest data structure 316, a tag-digest data structure 318, a correlation service 216, a collection 220 of correlations 218 of lifecycle identifiers 130 according to their lifecycle paths 804, and timestamps 432, in the form of data 118 and instructions 116, read from a removable storage medium 114 and/or another source such as a network connection, to form a configured storage medium. The configured storage medium 112 is capable of causing a computer system 202 to perform technical process steps for providing or utilizing vulnerability scope ascertainment functionality 204, as disclosed herein. The Figures thus help illustrate configured storage media embodiments and process (a.k.a. method) embodiments, as well as system and process embodiments. In particular, any of the process steps illustrated in FIG. 2, 5, 6, 7, 8, or 9, or otherwise taught herein, may be used to help configure a storage medium to form a configured storage medium embodiment.

Some embodiments use or provide a computer-readable storage device 112, 114 configured with data 118 and instructions 116 which upon execution by a processor 110 cause a computing system 202 to perform a process 600 to ascertain a lifecycle scope 210 of a cybersecurity vulnerability 132 of a software artifact 128. This process includes: obtaining 502 a first lifecycle identifier of the software artifact; determining 504 at least three additional lifecycle identifiers of the software artifact, based on at least the first lifecycle identifier, wherein the obtaining and the determining collectively identify a set of lifecycle identifiers which includes at least four of the following: a developer identifier, a commit identifier, a build identifier, a package digest, a package tag, or a workload identifier; displaying 126 the set of lifecycle identifiers; and mitigating 312 the cybersecurity vulnerability. In this example, the vulnerability is specifically a cybersecurity vulnerability which in the view of a cybersecurity professional poses a clear risk to confidentiality, integrity, availability, or privacy of data, or a clear risk of violation of applicable laws or regulations such as the GDPR, or both.

In some embodiments, mitigating 312 the cybersecurity vulnerability comprises generating 626 replacements of at least two of the following: the commit identifier, the build identifier, the package digest, or the workload identifier. This mitigation accordingly involves at least two of the following: editing and re-committing 634 source code in order to generate the replacement commit identifier, recompiling or linking in different compiled code or doing both in order to generate the replacement build identifier, including different executable code in a package order to generate the replacement package digest, or deploying different code in order to generate the replacement workload identifier.

In some embodiments, the process 600 includes getting 612 a package name and then obtaining the first lifecycle identifier from the package name, and the first lifecycle identifier includes at least one of a package digest or a package tag.

In some embodiments, the process 600 includes getting 614 a virtual machine identifier and then obtaining the first lifecycle identifier from the virtual machine identifier, and the first lifecycle identifier includes at least one of a workload identifier, a package digest, or a package tag.

In some embodiments, the process 600 includes getting 616 a cluster identifier and then obtaining the first lifecycle identifier from the cluster identifier, and the first lifecycle identifier includes at least one of a workload identifier, a package digest, or a package tag.

### Additional Observations

Additional support for the discussion of vulnerability scope ascertainment functionality 204 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, best mode, novelty, nonobviousness, inventive step, or industrial applicability. Any apparent conflict with any other patent disclosure, even from the owner of the present disclosure, has no role in interpreting the claims presented in this disclosure. With this understanding, which pertains to all parts of the present disclosure, examples and observations are offered herein.

Some embodiments trace security findings on running workloads to their origins throughout an entire development, build, and release lifecycle; some trace into or through at least two stages of a lifecycle. In some environments, a runtime security product 122 offers security findings for a running workload, such as findings of suspicious behavior that deviates from a defined profile. In many cases the follow-up investigation, as well as the actual fixes, are accomplished efficiently and effectively only if the problem causing the security finding is traced back to the origin components of the workload. Some embodiments provide information that correlates running workloads back to their origins throughout a development, build, and release life cycle, such as a developer identity and development machine identifier, a code repository identifier, a CI/CD system or build server or both, a drop repo identifier such as a container image registry entry, a workload identifier such as a container or process identifier, and a compute platform identifier such as a virtual machine identifier in a Kubernetes® cluster (mark of The Linux Foundation).

Some embodiments offer comprehensive visibility into an entire lifecycle for a running workload. Some embodiments trace security findings on running workloads to origins throughout entire development, build, and release life cycle by (1) correlating package signature to build artifact and code repository owning developers, (2) correlating a drop repository to a package signature, (3) correlating a pull package signature to a running workload, (4) cross-correlating to gain full visibility of running workload live-cycle, and (5) using the resultant full life-cycle context for security finding services.

Some embodiments monitor 216 a CI/CD system 710 and maintain a database 220 that maps 218 unique workload build artifacts' signatures 130 to the CI/CD system 710 or a build system 702 used to create the artifacts 128. Some embodiments query 628 development tools to get information stored in those tools, such as a code repository 440 identifier and the identity 402 of the developer that contributed to the code and initiated the build. Some embodiments collect 612, 614, 616, 622, 628 running workloads' signatures 130, either directly 628 from a compute platform itself 708 or by other methods such as disk scanning 622. Some embodiments collect 628, 622 drop repository 706 information from a workload configuration and add it to the running workload signature data 130. Some embodiments correlate some or all of the information 130 above to gain a more complete development-build-release lifecycle view of running workloads than would otherwise be available. The lifecycle view is then be used to enrich relevant security findings, find bugs and identify developers who are best situated to fix them, pre-emptively contain or curtail the scope of vulnerabilities, and otherwise enhance software functionality.

Some embodiments trace 504 security findings 132 on a running workload 428 to their origins 128 throughout the entire development, build, and release lifecycle 124 of the workload. In some environments and some scenarios, a full cloud-native workload lifecycle 124 begins when a developer 104 pushes 634 code 408 to a code repository 440. A build system 702 fetches 636 the code from the repository 440 and builds 714 from the fetched source code 408 components containing intermediate code 128, object code 128, assembly code 128, or executable code 128. The build system 702 output is packaged 416 and placed in a release 704. A CI/CD system 710 sends a package 416 to a drop repo 706, and then an orchestration platform 708 fetches 636 the package and runs 644 it, or in an alternative architecture the drop repo 706 sends 640 the package to the orchestration platform 708 and the orchestration platform runs 644 the package.

Under a fragmented approach which fails to correlate 214 security findings 132, security findings are viewed only at the context where they were found. For instance, findings yielded from a scan of a development machine 101 are viewed only on that development machine, findings yielded from a scan of a CI/CD system 710 are viewed only on that CI/CD system, findings yielded from a scan of a drop repository 706 are viewed only on that drop repository, and findings yielded from a runtime package vulnerability scan and runtime detection are viewed only on the orchestration platform 708.

The lack of correlations 214 in such a fragmented approach hinders efforts to mitigate vulnerabilities. For instance, suppose a security analyst receives a runtime scan result or an incident investigation result pointing out a cybersecurity vulnerability in a package X. The security analyst's job description does not include writing code, and the security analyst does not know where to find the source code files that fed into the development of package X. Indeed, the security analyst does not know which developer or developer team is likely to know who wrote the source code for package X, know where to find that source code, and know how to mitigate the vulnerability in the source code so that a replacement for package X can be built. The security analyst resorts to sending emails or making phone calls in an effort to locate someone who can help find the source code and fix it. This is a very inefficient effort, which is not certain to find the desired information even if it exists and would be available to the security analyst if the security analyst looked for it in the right place.

By contrast, the correlations 214 and other aspects of the functionality 204 taught herein permit an embodiment to efficiently obtain 502 and determine 504 the identities of the source code 408 of package X and the other artifacts 128 which are on a lifecycle path 804 that leads to package X, if that data exists and is accessible to the embodiment. The inefficiencies and uncertainties of relying on email or telephone pleas for information are avoided. The embodiment also efficiently ascertains the identity 402 of at least one relevant developer, namely, the developer who committed 634 package X source code to a repository 440. This developer ID will help the security analyst locate someone who can fix the source code to mitigate the cybersecurity vulnerability in package X.

Embodiments also help improve computing system security in other scenarios. For instance, suppose the security analyst receives a CI/CD system scan result pointing out a cybersecurity vulnerability in a component 128 such as an API library 128. To prioritize work, the security analyst wants to know whether this vulnerable API library 128 has been deployed yet, and if so, where and when it was deployed. Mitigating the vulnerability is a lower priority if the vulnerable library has not been deployed than if it has been deployed, and fixing or otherwise mitigating the vulnerability is a higher priority if the library is deployed in a production environment than if the library was only deployed in an internal testing environment. That is, having an entire lifecycle scope identification is useful for prioritization after finding a vulnerability 132 in the source code 408 or in a build 412, because the scope 210 determination indicates where this code usually runs, and thus helps determine how urgent it is to implement a fix.

Under the fragmented approach, the security analyst resorts to email or other inefficient and uncertain efforts to track the component forward to see if there is a path 804 leading to deployment 716 and execution 644. But an embodiment of functionality 204 will efficiently obtain 502 and determine 504 the identity and deployment status of any package X on a lifecycle path 804 forward from the vulnerable API library, if that data exists and is accessible to the embodiment.

Some embodiments provide or utilize a software development method which includes: correlating a signature of a package with a build artifact and a developer; further correlating at least one of the following with the package signature: a development code repository, a continuous integration tool, a continuous deployment tool, a version control tool, a drop repository, or an orchestration platform; receiving a security alert or a performance alert regarding the package; and utilizing the package signature and results of the correlating to retrieve lifecycle information of the package.

In some embodiments, a package signature can be matched throughout a release cycle. Details of a package signature depend on the package type. For example, in a container a digest can be used as a signature provided it is an architecture-specific digest that can be referenced at build, the registry and in the Kubernetes® run-time telemetry (mark of The Linux Foundation).

In some embodiments, package signature storage includes a fast bigdata analytics platform that allows for quick online queries, such Azure® Data Explorer (mark of Microsoft Corporation). An un-indexed cold storage such as some blob storage that won't allow for making correlation queries would not be suitable for signature storage.

### Technical Character

The technical character of embodiments described herein will be apparent to one of ordinary skill in the art, and will also be apparent in several ways to a wide range of attentive readers. Some embodiments address technical activities such as drilling down 606 into an enclosing package 416 to get nested package digests 420, querying 628 development tools for lifecycle identifiers 130 or related data such as timestamps 432, committing 634 source code 408 to a repository 440, and generating 626 replacement identifiers by editing code 408, recompiling code 128, rebuilding components 128, or repackaging components 128, which are each an activity deeply rooted in computing technology. Some of the technical mechanisms discussed include, e.g., an artifact identifier correlation service 216, commit-build data structures 314, build-digest data structures 316, tag-digest data structures 318, and tools 122, 710, 440, 702, 704, 706, 708 in a development environment 100. Some of the technical effects discussed include, e.g., resolved 630 ambiguities and filled 632 gaps in a lifecycle path 804 which correlates artifacts 128 (via identifiers 130), thus answering questions such as (a) whether a package based on problematic source code has been built and if so whether the package has also been deployed and if so when and where it was deployed, or (b) which developer contributed to a problematic package and thus is likely to be helpful in fixing the package. Thus, purely mental processes and activities limited to pen-and-paper are clearly excluded. Other advantages based on the technical characteristics of the teachings will also be apparent to one of skill from the description provided.

Software development and cybersecurity are each a technical activity which cannot be performed mentally, or entirely by pen and paper. One of skill understands that they are effectively part of software functionality, because their efficiency and effectiveness—or lack thereof—translates into software that functions efficiently and effectively—or does not. Improvements described herein to software development tools and cybersecurity tools, e.g., service 216 in pursuit of paths 804 with include inadequately performing or insecure artifacts, are accordingly improvements in software functionality.

Different embodiments provide different technical benefits or other advantages in different circumstances, but one of skill informed by the teachings herein will acknowledge that particular technical advantages will likely follow from particular embodiment features or feature combinations, as noted at various points herein. Any generic or abstract aspects are integrated into a practical application such as an enhanced integrated development environment (IDE) 122 which upon command displays the path(s) 804 that contain artifacts built using version(s) of the particular artifacts 128 under development using the IDE.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to determine whether any package based on vulnerable source code has been deployed, and how to identify a developer who contributed to problematic software deployed on a cluster or in a virtual machine. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, motivating examples, operating environments, tools, peripherals, software process flows, identifiers, data structures, data selections, naming conventions, notations, control flows, or other implementation choices described herein. Any apparent conflict with any other patent disclosure, even from the owner of the present disclosure, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.

ALU: arithmetic and logic unit

API: application program interface

BIOS: basic input/output system

CD: compact disc

CPU: central processing unit

DVD: digital versatile disk or digital video disc

FPGA: field-programmable gate array

FPU: floating point processing unit

GDPR: General Data Protection Regulation

GPU: graphical processing unit

GUI: graphical user interface

HTTPS: hypertext transfer protocol, secure

IaaS or IAAS: infrastructure-as-a-service

ID: identification or identity

IDE: integrated development environment

IL: intermediate language

LAN: local area network

OS: operating system

PaaS or PAAS: platform-as-a-service

RAM: random access memory

ROM: read only memory

TPU: tensor processing unit

UEFI: Unified Extensible Firmware Interface

UI: user interface

WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (Saas), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account, or by software on behalf of a user, or by hardware on behalf of a user. Activity is represented by digital data or machine operations or both in a computing system. Activity within the scope of any claim based on the present disclosure excludes human actions per se. Software or hardware activity “on behalf of a user” accordingly refers to software or hardware activity on behalf of a user device or on behalf of a user account or on behalf of another computational mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

“Software component” means source code, any digital item processed by a build tool to create part of an executable code, and executable code.

“Security vulnerability” means any aspect of or gap in the structure or operation of a software component which permits or aids a break or reduction of confidentiality, integrity, availability, or privacy of the software component or of data which is accessible to the software component. Note that under this definition bugs and configuration problems are security vulnerabilities because they impact availability.

“Security vulnerability lifecycle scope” means the set of software components that exhibit a particular security vulnerability or contribute code to any of those software components. For example, if a virtual machine has a security vulnerability, then the lifecycle scope of that security vulnerability includes, e.g., the executable binary image of the virtual machine, the individual executable code or object code components that were placed in the binary image during build or deployment, and the source code of those individual executable code or object code components. Notice that the source code is part of the lifecycle scope even when the source code is not the origin of the vulnerability, e.g., if a workload contains malware that was injected during deployment after build, the workload source code may be fine but it is still part of the lifecycle scope.

“Package” means a software component produced by a build pipeline.

“Package digest” means a hash or other value which is computed from the content of a package. If the package content changes, then the package digest will change. Also, every time there's a build the package digest, or signature in other words, will change even when it's based on the same source code. The time of the build is also a factor in some environments.

“Package tag” means a label or other value which is associated with a package. The same package tag may be associated at different times with different packages. That is, the package tag does not necessarily change after the package content changes.

“Build pipeline” means a set of coordinated tools which build an executable package from source code and possibly other software components, e.g., image files. Some examples include Jenkins® (mark of LF Charities, Inc.), Github® Actions (mark of GitHub, Inc.), and Azure® DevOps Pipelines (mark of Microsoft Corporation).

“Build ID” means a value which identifies a particular build, namely, a particular set of source code and possibly other software components, and build configuration parameters.

“Build configuration parameters” mean compiler settings which indicate, e.g., which processor architecture and operating system the package being built will execute on, whether to include profiling instrumentation in the package being built, and whether to perform particular optimizations.

“Source repo” means a version-controlled repository which contains source code. Some examples include GitHub® (mark of GitHub, Inc.), Gitlab® (mark of Gitlab BV), and Azure® DevOps Repos (mark of Microsoft Corporation).

“Commit ID” means a value which identifies a particular set of source code files, including the version of each file, in a source code repo.

“Drop repo” means a repository which contains packages and their respective package digests. A package in a drop repo may also have one or more associated package tags. Some examples include container registry, blob storage.

“Deployment platform” means a tool or other platform which selects packages from a drop repo and moves the packages to a runtime. Some examples include orchestration platforms, Kubernetes® (mark of The Linux Foundation), Azure® Function, Azure® Container Instances (marks of Microsoft Corporation), Lambda® (mark of Lambda Labs, Inc.), AWS Fargate® (mark of Amazon Technologies, Inc.).

“Runtime” means a package execution environment.

“Workload” means code which was executing in a runtime or is executing in a runtime. A workload includes one or more packages. Some examples of a workload include a virtual machine, an application, or code running on a cluster.

“Lifecycle Identifiers” include: Developer ID, Commit ID, Build ID, Package Digest, Package Tag, and Workload ID.

“Lifecycle Locations” include: Source Repo, Drop Repo, and Runtime.

“Lifecycle Services” include: Build Service, Deployment Service, and Correlation Service.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Vulnerability scope ascertainment operations such as drilling 606 into an enclosing package 426, querying 628 developer tools 122, generating 626 an identifier 130 by committing 634 code 408 to a repository or compiling code or packaging components, determining 504 identifiers 130 using specialized data structures 314, 316, 318, 220, and many other operations discussed herein, are understood to be inherently digital. A human mind cannot interface directly with a CPU or other processor, or with RAM or other digital storage, to read and write the necessary data to perform the vulnerability scope ascertainment steps 600 taught herein even in a hypothetical prototype situation, much less in an embodiment's real world large computing environment. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as associating, building, committing, compiling, correlating, deploying, detecting, determining, discovering, drilling, editing, fetching, filling, generating, getting, guiding, identifying, labeling, mitigating, noting, obtaining, packaging, producing, querying, releasing, resolving, running, scanning, sending, submitting, supporting, utilizing (and associates, associated, builds, built, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe embodiments by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment; includes one or more systems 102
101 machine in a system 102, e.g., any device having at least a processor 110 and a memory 112 and also having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or set of processors; includes hardware
112 computer-readable storage medium, e.g., RAM, hard disks
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers
122 tool in a computing system, e.g., software development tool, security tool, communication tool, etc.; computational and hence non-human
124 software development lifecycle, also referred to as “software lifecycle”, “development lifecycle”, or “lifecycle”; many views exist about how software development progresses over time, including views which discuss some kind of software lifecycle; these views are not mutually consistent, e.g., different definitions of software lifecycle may posit different stages in that lifecycle, different numbers of stages, and even different goals for stages that have the same or similar names as one another; for present purposes, a lifecycle includes one or more of: a write stage 712, a build stage 714, and a deploy stage 716, with the understanding that progression through a software development lifecycle is not always linear and forward, e.g., earlier stages may be repeated; stages may also be referred to as phases, steps, milestones, periods, chapters, etc.
126 display screens, also referred to as “displays”
128 artifact in a computing system; digital or computational or both; some examples are files 448 and other artifacts which have a data storage capability, virtual machines or clusters and other artifacts which have a computational capability, and network 108 artifacts which have a data transmission capability; a given artifact may have different kinds of capabilities, e.g., code or components used or produced by a build operation 412 often have both compute and storage capabilities and many also have transmission capabilities
130 artifact identifier, as represented in a computing system 202
132 vulnerability, as represented in a computing system 202; unless expressly limited, “vulnerabilities” covers both cybersecurity vulnerabilities and performance flaws which are not necessarily cybersecurity vulnerabilities
134 cloud, also referred to as cloud environment or cloud computing environment
136 computing hardware not otherwise associated with a reference number 106, 108, 110, 112, 114
202 enhanced computing system, i.e., system 102 enhanced with vulnerability scope ascertainment functionality as taught herein
204 vulnerability scope ascertainment functionality, e.g., software or specialized hardware which performs or is configured to perform steps 502 and 504, or step 604, or any of steps 622, 630, 632, or 642, or any software or hardware which performs or is configured to perform a novel method 600 or a computational vulnerability scope ascertainment activity first disclosed herein
206 computationally ascertain a path 804 having at least two artifact identifiers 130 by at least one of steps 630 or 632
208 cybersecurity in a system 202; also referred to as “security”; a status, condition, or characteristic which directly impacts the confidentiality, integrity, availability, or privacy of data in a computing system 102
210 scope of a vulnerability, in terms of which artifacts 128 contribute to the vulnerability (contribute in the “but for” sense) or have the vulnerability; as represented in a system 202
212 software development environment; an environment 100 in which a software development operation (software editing, compiling, committing 634, building 412, debugging, profiling, or deploying) occurs
214 computationally correlate two or more identifiers 130 as being in the same path 804 as one another, e.g., as being the input and respective output of a software development operation
216 computational service which performs correlation 214
218 a result of computational correlation 214, e.g., a data structure containing correlated identifiers with an explicit or implicit indication they are on the same path 804; as represented in a computing system 202
220 correlations 218 in a database or other searchable format
302 computationally determine a path 804 despite gaps or ambiguities, by filling 632 a gap or resolving 630 an ambiguity in a sequence of identifiers 130 that form the path
304 gap in a sequence of identifiers 130 that would form a path 804 when the gap is filled, e.g., a gap between: a developer ID and a compiled component 128 ID, a developer ID and a package 416 tag or digest, a developer ID and a virtual machine ID or a cluster ID or a workload ID, a commit ID and a package 416 tag or digest, a commit ID and a virtual machine ID or a cluster ID or a workload ID, and so on; removal of any double-ended arrow in FIG. 9 that divides the graph into disconnect parts creates a gap 304
306 ambiguity in a sequence of identifiers 130 that would form a path 804 when the ambiguity is resolved, e.g., when identifiers in adjacent parts of a path do not correspond 1-to-1, as when a package name corresponds to an enclosing package digest and hence to multiple nested package digests, or when a file name corresponds to multiple commit IDs, or a package tag corresponds to multiple package digests, or a package name corresponds to multiple builds, for example
308 lifecycle data, as represented in a computing system 102, e.g., identifiers 130, timestamps 432, names 422, 450, logs 446
310 support an effort by computationally displaying or otherwise providing data which enables, facilitates, or promotes the effort
312 vulnerability mitigation in a computing system, e.g., performance improvement, bug fix, security risk reduction
314 commit-build data structure in a computing system 202; may be implemented as a key-value pair, table, or other structure that associates a commit ID with a respective build ID or vice versa
316 build-digest data structure in a computing system 202; may be implemented as a key-value pair, table, or other structure that associates a build ID with a respective package digest or vice versa
318 tag-digest data structure in a computing system 202; may be implemented as a key-value pair, table, or other structure that associates a package tag with a respective package digest or vice versa
320 mitigation tool, e.g., software development tool, cybersecurity investigation tool, cybersecurity control in a system 102
322 interface generally
402 developer ID in a system 202
404 particular commit 634 of source code to a repository 440
406 commit ID of a commit 404
408 source code in a system 102
410 source code identifier, e.g., in a repo 440 or a build system
412 particular build operation or its computational result in a system 202
414 build ID of a build 412
416 package in a system 102
418 package tag in a system 202
420 package digest in a system 202
422 package name in a system 202
424 nested package in a system 102
426 enclosing package in a system 102
428 workload in a system 102
430 workload ID of a workload 428
432 timestamp in a system 202
434 set of lifecycle data
436 virtual machine in a system 102
438 virtual machine ID in a system 202
440 source code repository (a.k.a. “repo”)
442 cluster in a system 102
444 cluster ID in a system 202
446 log in a system 102; also refers to computational activity of logging which creates or updates a log
448 file, blob, or other storage artifact in a system 102
450 name of file 448 as represented in a system 202
500 flowchart; 500 also refers to vulnerability scope ascertainment processes that are illustrated by or consistent with the FIG. 5 flowchart
502 computationally obtain a lifecycle identifier, e.g., from a user interface or by reading a log, reading a manifest, or reading a tool query response, or by any of steps 610, 612, 614, 616, 630
504 computationally determine an additional lifecycle identifier, e.g., by reading a log, reading a manifest, reading a tool query response, or indexing into and reading from a mapping 314, 316, or 318, or any of steps 606, 622, 630, 632
506 computationally utilize a scope ascertainment
508 computational result of ascertaining 206 a scope, e.g., a path 804
512 computationally guide a mitigation tool, e.g., by providing data or instructions to the mitigation tool
600 flowchart; 600 also refers to vulnerability scope ascertainment processes that are illustrated by or consistent with the FIG. 6 flowchart, which incorporates the FIG. 5 flowchart and other steps taught herein
602 computationally associate identifiers, e.g., using a data structure designed for that purpose; mere coincidental appearance of two identifiers, e.g., in a list of system assets or a log, does not qualify as association 602
604 computationally produce a set of correlated identifiers by performing steps taught herein
606 computationally drill into an enclosing package to find nested package identifiers
608 computationally submit identifier to a cybersecurity tool
610 computationally get a source code file name, e.g., from a user interface or a log
612 computationally get a package name, e.g., from a user interface or a log 614
614 computationally get a virtual machine identifier, e.g., from a user interface or a log
616 computationally get a cluster identifier, e.g., from a user interface or a log
618 computationally discover whether code has been deployed, e.g., from a log or a tool 708 query response
620 computationally note that a component is vulnerable, e.g., from a user interface or a log or a cybersecurity tool report
622 computationally obtain or determine an identifier based on more than a log or without using a log
624 computationally scan an artifact for a vulnerability
626 computationally generate a replacement identifier by performing a software development operation
628 computationally query a tool for data, e.g., via an API
630 computationally resolve an ambiguity in a path 804, e.g., by eliminating a possible identifier from the path; full resolution is a goal but may be unattainable in a particular circumstance due to lack of available data
632 computationally fill a gap in a path 804, e.g., by adding an identifier the the path; fully filling the gap is a goal but may be unattainable in a particular circumstance due to lack of available data
634 computationally commit source code to a repo 440
636 computationally fetch a component or an identifier
638 computationally label a component
640 computationally send a component
642 computationally detect an ambiguity or gap in a path 804, e.g., using a paths graph data structure along the lines of FIG. 9
644 run code, also referred to as “executing” code
646 any step or item discussed in the present disclosure that has not been assigned some other reference numeral; 646 may thus be shown expressly as a reference numeral for various steps or items or both, and may be added as a reference numeral (in the current disclosure or any subsequent patent application which claims priority to the current disclosure) for various steps or items or both without thereby adding new matter
700 cloud lifecycle; an example of a lifecycle 124
702 build system
704 release tool
706 drop repository
708 orchestration platform, also referred to as “orchestrator” or deployment tool
710 continuous integration/continuous deployment (CI/CD) system
712 write stage of lifecycle, e.g., when software is written by a developer
714 build stage of lifecycle
716 deploy stage of lifecycle
800 example architecture
802 security service, also referred to as security control or security tool or cybersecurity service/tool/control
804 lifecycle path, as represented in a system 202; includes two or more identifiers 130 which correspond to one another a input to or output from a particular instance of a software development operation
900 graph data structure in a system 202 representing a set of one or more overlapping paths 804, in that at least one of the following nodes in the path has only a single identifier: source code ID node, commit ID node, build ID node, package ID node, deployed package ID node (workload ID, cluster ID, or virtual machine ID)

### CONCLUSION

Some embodiments gather 502, 504 and correlate 218 software artifact identifiers 130 to determine a lifecycle path 804 connecting disparate artifacts 128 from different lifecycle stages 712, 714, 716. Embodiments support 310 developers 104 or security personnel 104 who are facing inquiries such as which developer can shed light on a particular problematic 132 workload 428, whether a package 416 based on a particular vulnerable 132 source code 408 has been deployed 716, and whether a given workload 428 running on a cluster 442 or a virtual machine 436 was built 412 with any components 128 that currently have known vulnerabilities 132. Embodiments proactively fill 632 gaps 304 and resolve 630 ambiguities 306 in a lifecycle path 804, by using commit-build data structures 314, build-digest data structures 316, tag-digest data structures 318, responses 308 to development tool 122 queries 628, results 308 of drilling 606 into enclosing packages 426 to find nested package 424 digests 420, lifecycle graphs 900, timestamps 432, and other lifecycle data 308.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; one is not required to recite every nuance within the claims themselves as if no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

1. A software development computing system which is capable of ascertaining a lifecycle scope of a software vulnerability, the computing system comprising:
a digital memory;
a processor set comprising at least one processor, the processor set in operable communication with the digital memory;
a collection of lifecycle correlations residing in and configuring the digital memory, the collection comprising a commit-build data structure which associates a commit identifier with a build identifier, and a build-digest data structure which associates a build identifier with a package digest; and
a correlation service which upon execution by the processor set produces a set of correlated lifecycle identifiers, wherein the set of correlated lifecycle identifiers comprises: a developer identifier, a source code identifier which identifies a source code that was committed to a source repository under the developer identifier and was given the commit identifier, the source code corresponding to a package that was built using at least the source code, and a workload identifier which identifies a workload that comprises the package.

2. The computing system of claim 1, wherein the package is a nested package within an enclosing package and the package digest is a nested package digest, the enclosing package comprises at least one other nested package having a respective other nested package digest, and the enclosing package has a respective enclosing package digest.

3. The computing system of claim 1, wherein the digital memory is also configured by a tag-digest data structure which associates a package tag with a package digest and a timestamp.

4. A process performed by computing system to ascertain a lifecycle scope of a vulnerability of a software artifact, the process comprising:
obtaining a first lifecycle identifier of the software artifact;
determining at least three additional lifecycle identifiers of the software artifact, based on at least the first lifecycle identifier, wherein the obtaining and the determining collectively identify a set of lifecycle identifiers which comprises at least four of the following: a developer identifier, a commit identifier, a build identifier, a package digest, a package tag, or a workload identifier; and
submitting the set of lifecycle identifiers to a security vulnerability mitigation tool or a software development tool.

5. The process of claim 4, comprising at least one of:
getting a source code file name and then obtaining the first lifecycle identifier from the source code file name, wherein the first lifecycle identifier comprises at least one of a developer identifier or a commit identifier;
getting a package name and then obtaining the first lifecycle identifier from the package name, wherein the first lifecycle identifier comprises at least one of a package digest or a package tag;
getting a virtual machine identifier and then obtaining the first lifecycle identifier from the virtual machine identifier, wherein the first lifecycle identifier comprises at least one of a workload identifier, a package digest, or a package tag; or
getting a cluster identifier and then obtaining the first lifecycle identifier from the cluster identifier, wherein the first lifecycle identifier comprises at least one of a workload identifier, a package digest, or a package tag.

6. The process of claim 4, further comprising discovering whether executable code based on a vulnerable software component has been deployed, by utilizing the set of lifecycle identifiers.

7. The process of claim 4, further comprising noting that a software component is vulnerable and identifying a developer who contributed to the software component, by utilizing the set of lifecycle identifiers.

8. The process of claim 4, wherein the process identifies the set of lifecycle identifiers based at least partially on information that is not present in any log in the computing system.

9. The process of claim 4, wherein the process determines a nested package digest from an enclosing package digest.

10. The process of claim 4, wherein the process determines a package digest using a workload tag of a workload which is marked as having a vulnerability and using a timestamp of the workload.

11. The process of claim 4, wherein the obtaining and the determining collectively identify the set of lifecycle identifiers, and the set of lifecycle identifiers comprises at least five of the following: a developer identifier, a commit identifier, a build identifier, a package digest, a package tag, or a workload identifier.

12. The process of claim 4, wherein the obtaining and the determining collectively identify the set of lifecycle identifiers, and the set of lifecycle identifiers comprises a developer identifier, a commit identifier, a build identifier, a package digest, a package tag, and a workload identifier.

13. The process of claim 4, wherein the process comprises at least one of the following determinations:
determining the package digest using the build identifier or determining the build identifier using the package digest;
determining the package digest using the workload identifier or determining the workload identifier using the package digest;
determining the package digest using the commit identifier or determining the commit identifier using the package digest;
determining the package digest using the developer identifier or determining the developer identifier using the package digest;
determining the workload identifier using the commit identifier or determining the commit identifier using the workload identifier; or
determining the workload identifier using the developer identifier or determining the developer identifier using the workload identifier.

14. The process of claim 13, wherein the process comprises at least two of the determinations.

15. The process of claim 13, wherein the process comprises at least three of the determinations.

16. A computer-readable storage device configured with data and instructions which upon execution by a processor cause a computing system to perform a process to ascertain a lifecycle scope of a cybersecurity vulnerability of a software artifact, the process comprising:
obtaining a first lifecycle identifier of the software artifact;
determining at least three additional lifecycle identifiers of the software artifact, based on at least the first lifecycle identifier, wherein the obtaining and the determining collectively identify a set of lifecycle identifiers which comprises at least four of the following: a developer identifier, a commit identifier, a build identifier, a package digest, a package tag, or a workload identifier;
displaying the set of lifecycle identifiers; and
mitigating the cybersecurity vulnerability.

17. The storage device of claim 16, wherein mitigating the cybersecurity vulnerability comprises generating replacements of at least two of the following: the commit identifier, the build identifier, the package digest, or the workload identifier.

18. The storage device of claim 16, wherein the process comprises getting a package name and then obtaining the first lifecycle identifier from the package name, and wherein the first lifecycle identifier comprises at least one of a package digest or a package tag.

19. The storage device of claim 16, wherein the process comprises getting a virtual machine identifier and then obtaining the first lifecycle identifier from the virtual machine identifier, and wherein the first lifecycle identifier comprises at least one of a workload identifier, a package digest, or a package tag.

20. The storage device of claim 16, wherein the process comprises getting a cluster identifier and then obtaining the first lifecycle identifier from the cluster identifier, and wherein the first lifecycle identifier comprises at least one of a workload identifier, a package digest, or a package tag.
